(19) United States
(12) Patent Application Publication
(10) Pub. No.: US 2015/0169593 A1
(43) Pub. Date: Jun. 18, 2015

(54) CREATING A PRELIMINARY TOPIC STRUCTURE OF A CORPUS WHILE GENERATING THE CORPUS

(71) Applicant: ABBYY InfoPoisk LLC, Moscow (RU)

(72) Inventors: Daria Nikolaevna Bogdanova, Moscow (RU); Nikolay Yurievich Kopylov, Moscow (RU)

(21) Appl. No.: 14/508,228

(22) Filed: Oct. 7, 2014

(30) Foreign Application Priority Data
Dec. 18, 2013 (RU) 2013156261

(51) Int. Cl. G06F 17/30

(52) U.S. Cl. CPC G06F 17/3071

(57) ABSTRACT

Disclosed are systems, computer-readable mediums, and methods for creating a topic structure of a corpus while constructing the corpus. A first set of documents is received, and each document is converted into a text representation. The text representation of the first set of documents is clustered into original topics. Each document in the first set of documents is labeled based upon the clustering of the first set of documents. A classifier is built based on the labeling of each document in the first set of documents. A second set of documents is received, and each document in the second set of documents is classified, using the classifier, into one or more topics from the original topics.

### CROSS REFERENCE TO RELATED APPLICATIONS

This application claims the benefit of priority under 35 USC 119 to Russian Patent Application No. 2013156261, filed Dec. 18, 2013; the disclosure of which is incorporated herein by reference.

### BACKGROUND

Building a corpus of documents can be a two-step process of collecting electronic documents and then analyzing the entire corpus. The two-step process to building a corpus can include (1) initially creating an assumed topic structure, (2) collecting the documents of the corpus, and then performing a topic categorization on the documents. Once a corpus has been created, a topic categorization of the corpus can be created by classifying the documents in the corpus. Documents in the corpus can then be assigned a topic or a number of topics based upon the topic categorization. The categorization can be done by a machine learning process using a classification method. Analyzing the corpus can also include sorting the electronic documents and/or clustering the electronic documents.

This approach has several drawbacks. The list of possible topics needs to be predefined and, all documents need to fit into predefined topics. The latter makes this approach inapplicable when dealing with unknown topics, such as a corpus obtained from a wide variety of diverse documents. For example, documents can be retrieved from a network, e.g., the internet, that cover a number of topics. When a topic of a document in a corpus is not within the predefined categories, the process of creating the initial topic structure has failed. In addition, the manual analysis of the corpus to determine the topics of the corpus is not a feasible solution since the corpus can include documents added at a later time. Further, the massive amount of data in the corpus makes manual analysis to create the topic structure unfeasible.

### SUMMARY

Disclosed are systems, computer-readable mediums, and methods for creating a topic structure of a corpus while constructing the corpus. A first set of documents is received, and each document is converted into a text representation. The text representation of the first set of documents is clustered into original topics. Each document in the first set of documents is labeled based upon the clustering of the first set of documents. A classifier is built based on the labeling of each document in the first set of documents. A second set of documents is received, and each document in the second set of documents is classified, using the classifier, topics from the original topics.

Also described herein are systems, computer-readable mediums, and methods for simultaneously performing a preliminary estimation of a topic structure of a corpus prior to the generation of the complete corpus and generating the topic structure. A relatively small dataset is initially collected. The dataset can be representative of the eventual complete corpus, but is not required to be so. A clustering process is applied to the collected dataset. Then a cluster labeling is applied to the dataset, to obtain labeled data. The labeled data can be used as a training set to classify additional unlabeled data. Unlabeled data can then be obtained and classified. The classification method for performing the classifying of the obtained unlabeled data could be an open-class classification. In this embodiment, the texts that do not have a class initially assigned by the classification method can be clustered and labeled into a new class. As a result, a labeled corpus is obtained without having to specify the topic structure of the corpus.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 shows a flowchart of operations for building a corpus with induced topic structure in accordance with one embodiment.

FIG. 2A shows a flowchart of operations for constructing a set of labeled texts in accordance with one embodiment.

FIG. 2B shows a flowchart of operations for clustering in accordance with one embodiment.

FIG. 3 shows a flowchart of operations for classification in accordance with one embodiment.

FIG. 4 shows a flowchart of operations for assigning topics to documents in accordance with one embodiment.

FIG. 5 shows a flowchart of operations for classifying documents using an open class topic classifier in accordance with one embodiment.

FIG. 6 shows hardware 600 that may be used to implement the techniques described herein.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Many research studies, including those on computational linguistics, sentiment analysis, etc., are based on text corpora. Research is carried out by analyzing with a text corpus. For example, a corpus can be analyzed to determine reliable statistics on the usage of a particular word or to find out if a word is used more by men or women, older or younger people. Some analyses benefit from a large corpus that is balanced and representative of a population. A text corpus can be enriched with annotation depending on the purposes of its usage. The annotation can be word or sentence-level, such as morphological or syntactic annotation. The annotation can also be text-level, i.e., texts can be annotated with information about their content, author, etc., such as topic, genre, author's gender, age, etc. Topic annotation is a common text-level annotation. Texts in the corpus can be associated with a topic label or a number of topic labels. For example, a document about football injury treatment can be associated with two topic labels: “Sport” and “Medicine,” or either of them.

Current methods perform corpus construction and topic identification separately. For example, to obtain a corpus with topic annotation, first, documents are collected; and second, topic identification is performed on the obtained documents. Implementations of various disclosed embodiments relate to construction of a corpus concurrently with generating the topic structure of the corpus. The disclosed embodiments do not rely on a predefined topic structure. Rather, the topic structure is automatically estimated while generating the corpus. Accordingly, there is no need for a predefined set of topics or derivation of textual information to determine the predefined set of topics. A topic structure of a corpus can be generated from a large number of “unknown” documents that are received from crawling a network, such as the internet. The topic structure is not known before the crawling of documents. Disclosed embodiments describe how the topic structure can be estimated from the large number of “unknown” documents while the corpus is being generated.

Topic identification can be undertaken by a machine learning method, e.g., a classification method. Given a training set, e.g., a set of documents labeled with topics, labels can be assigned to unseen documents labels of the documents in the training set. Some embodiments can assign a single label to each document. Other embodiments can assign one or more labels. In addition, open-class classifiers can assign zero, one, or more than one label to each document. The assignment of more than one label may be appropriate for many documents, since documents can cover multiple topics.

A corpus of texts can be generated from social media such as online blogs, chats, forums, reviews, etc. Texts obtained from these sources can cover a large number of topics. Due to the unstructured nature of these texts, the topics can change over time. In one embodiment, an initial set of documents/texts for a corpus can be obtained from the Internet using crawling techniques. For example, a dump of all blog posts from a blog service, forum, etc., can be obtained. A later crawl of all new blog posts from the same blog service, e.g., a crawl from a few weeks later can be done. The new documents can be added to the corpus. The topic structure of the new documents can have a topic structure different than the topic structure of the first set of documents or of the corpus. This can be due to recent blog posts that cover topics related to recent events. In such cases, when categories are not known in advance, unsupervised techniques, such as clustering, can be applied. Methods that rely on a number of predefined clusters, however, will not work by themselves since the topics are not known in advance, such that the predefined clusters can be defined. In addition, the amount of text can be too large for hierarchical and density-based clustering.

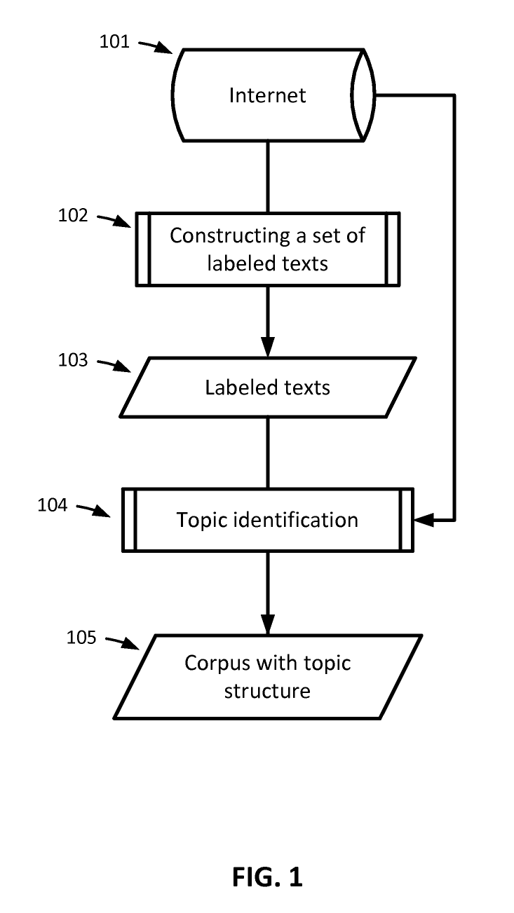

FIG. 1 shows a flowchart of operations for building a corpus with induced topic structure in accordance with one embodiment. To generate the preliminary topic structure of a corpus, one or more documents are retrieved (101). These documents can be obtained from a database or a network, such as the internet. A set of labeled texts (103) is constructed (102) from the one or more documents. Additional documents can then be retrieved from the same or different database used to obtain the original documents, or the same or different network used to obtain the original documents. Topic identification can then be performed on these additional documents (104). The set of labeled texts (103) can be used as a training set in the topic identification (104). The additional documents are added to the corpus. With the topic identification of the additional documents, a corpus with topic structure is obtained (105).

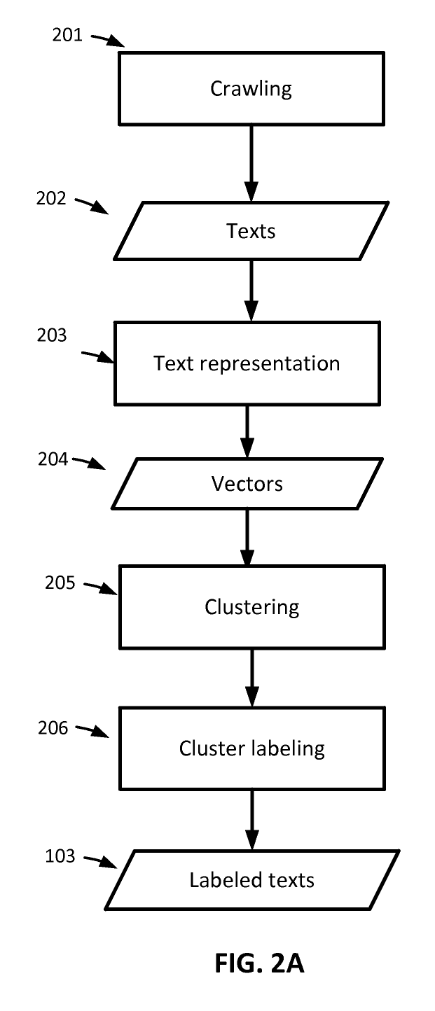

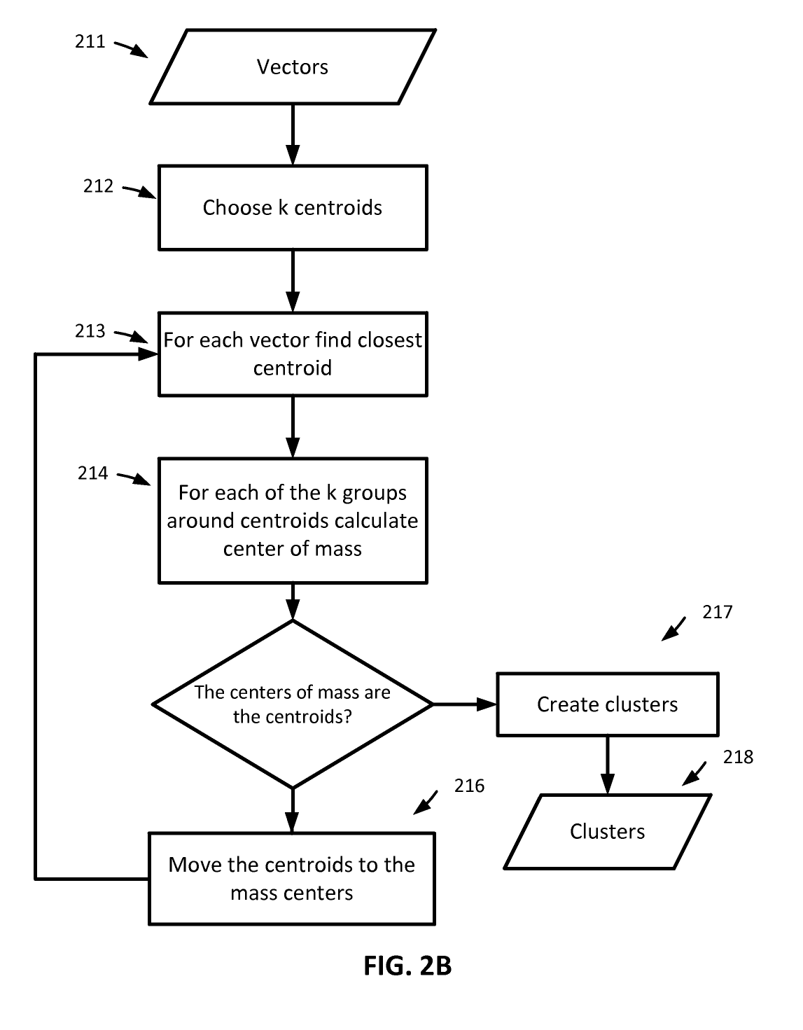

FIG. 2A shows a flowchart of operations for constructing a set of labeled texts (102) in accordance with one embodiment. In this example, documents are obtained by crawling (201) a database or a network, such as the internet, to retrieve one or more documents/texts (202). In one embodiment, the crawling step may be performed with an existing crawling method, such as the one described in the following technical publication: J. Pomikalek. Removing Boilerplate and Duplicate Content from Web Corpus, PhD dissertation, Brno, Masaryk University, 2011. A crawling strategy can be based on a yield rate concept. In one embodiment, the yield rate for each page is the ratio of the text size (in bytes) suitable for the corpus to the size of all text retrieved as part of the crawling (201), e.g., yield

$$rate = \frac{\vert final data \vert}{\vert downloaded data \vert} .$$

In another embodiment, the threshold is based upon the total amount of text in the corpus. The crawler selects only those pages for which the value of yield rate is higher than a threshold. The threshold can be defined dynamically depending on the number of already crawled pages. For example, the threshold may be defined as: threshold(total)=0.01*(log₁₀ (total)−1), where total is the total number of pages already crawled or present in the corpus, and threshold(total) is the threshold. Thus, the greater the total number of pages crawled or present in the corpus, the higher the threshold. For example, if there are only 10 pages currently in the corpus, the threshold is 0. When the number of documents in the corpus reaches 10,000 pages, the threshold becomes equal to 0.03. Using the yield rate concept can ensure that every domain is represented in the corpus, and every domain reaches the threshold at one point, such that no domain is overrepresented. This technique, therefore, can create a balanced corpus.

As a result of the crawling step, a set of documents/texts is obtained (202). The texts can then be converted into a different representation, such as a text representation (203). For example, the documents can be transformed into numerical vectors. The numerical vectors can then be analyzed, rather than directly analyzing the documents/texts. In one embodiment, techniques based on word frequencies or occurrences can be applied, as those presented in this technical publication: Salton G; McGill M J (1986). Introduction to Modern Information Retrieval. McGraw-Hill. ISBN 0-07-054484-0. In one embodiment, to create text representations of documents, a list of all words in all documents is collected. Let N be the total number of different words in all documents. Each document is then converted into an N-dimensional vector, with each component of the vector corresponding to one of the words from the list of all words in all documents. The value of each component indicates if the document contains the corresponding word. The value can depend on the frequency of the word in the document and/or other documents. In one embodiment, a value of each component can be calculated as the product of the word frequency and the inverted document frequency. The word frequency can be calculated in a variety of ways. For example, the word frequency wf(w,d) can be calculated as a frequency f(w,d) of the word w in the document d, i.e. wf(w,d)=f(w,d). In another embodiment, the word frequency can be calculated as wf(w,d)=log(f(w,d)+1). In yet another embodiment, the word frequency can be calculated as

$$w f ( w , d ) = p + \frac{p * f ( w , d )}{max \{ f ( w , d ) : w ∈ d \}} ,$$

where p is some small value, for example, p=0.5. Using this formula prevents bias towards longer documents. The inverted document frequency idf(w,d) can be calculated as:

$$i d f ( w , d ) = log \frac{\vert D \vert}{\{ d ∈ D : w ∈ d \}} ,$$

where D is the set of all documents. The final value of the component is calculated by multiplying the two values, wf(w,d)*idf(w,d). Calculating the value for each component for each vector creates the vectors (204) that represent the documents within the corpus.

Clustering (205) can be performed on the vectors (204). An method that does not require the number of clusters to be predefined can be used, such as the method presented in the following technical publication: Martin Ester, Hans-Peter Kriegel, Jorg Sander, Xiaowei Xu (1996-). “A density-based algorithm for discovering clusters in large spatial databases with noise,” In Evangelos Simoudis, Jiawei Han, Usama M. Fayyad. Proceedings of the Second International Conference on Knowledge Discovery and Data Mining (KDD-96). AAAI Press. pp. 226-231.

In another embodiment, a clustering method that requires the number of clusters to be predefined such as k-means can be used. The number of clusters may be tuned with any existing method for estimating the number of clusters. FIG. 2B shows a flowchart of operations for clustering in accordance with one embodiment. The operations can be repeated many times using different values for k. Vectors (211) can be those shown in FIG. 2A as 204. In one embodiment, k random vectors are defined as centroids (212). Each vector representing a document in the corpus is assigned to the closest centroid (213) according to some predefined similarity/distance measure. In another embodiment, a subset of vectors can be used. After the documents in the corpus have been assigned to the closest centroid, the mass center of each centroid is determined based upon the vectors representing documents assigned to a particular centroid. The center point of the centroid is then moved to this mass center (216). The vectors representing documents are then reassigned to the centroids and the process repeats. The process terminates, when the mass center does not move or moves less than a predetermined threshold. A cluster is created for each centroid (217) to make multiple clusters (218). This process can be repeated for multiple different values of k. The best value of k can be selected based on a statistical analysis of the obtained cluster structures.

In another embodiment, clustering can be done using two parameters, mnp, the minimal number of points in a cluster, and thr, a threshold value. Given these two values, a random point in the corpus vector space is selected. All document vectors that are within a distance equal to or smaller than thr are joined together. In another embodiment, a subset of vectors can be used. If the total number vectors joined with a point is greater than mnp, a cluster is formed based upon the vectors. Otherwise, the vectors are marked as outliers. Next, an unused point in the corpus vector space is selected, and the process repeats. In one embodiment, only outlier vectors are used in later iterations. In another embodiment, all document vectors are used for each iteration, such that, a particular vector may be joined with multiple points. The process continues until all document vectors have been joined with at least one point. In another embodiment, the process continues until all points have been visited. The process creates a list of clusters with each vector being associated with at least one point in the corpus vector space. Obtained clusters can then be labeled (206). Cluster labeling (206) can be done with an existing method, for example, an method based on feature selection criteria can be used. As a result, the set of labeled texts 103 is obtained.

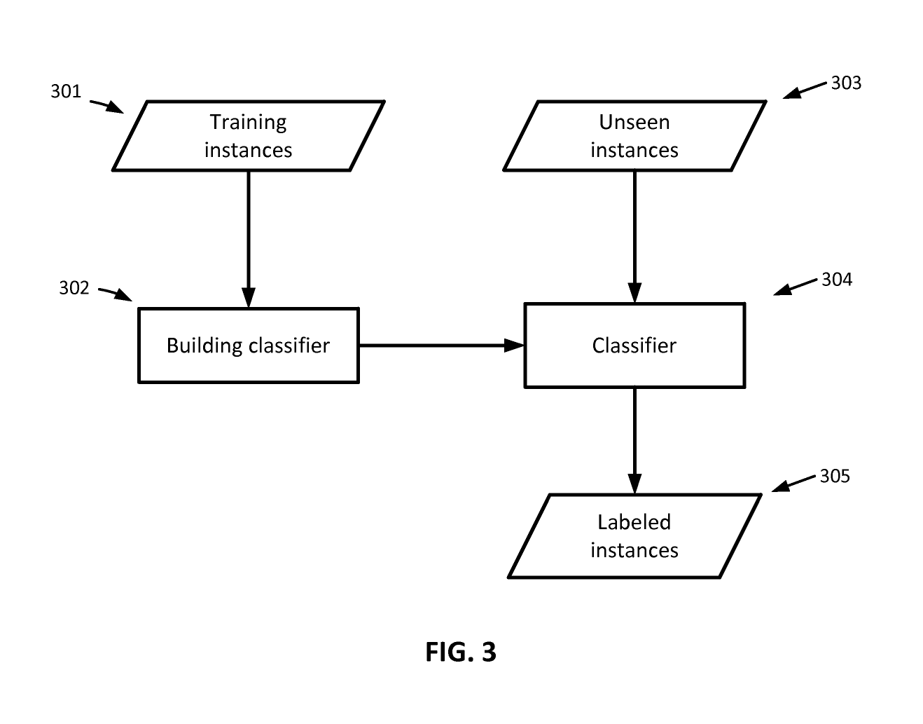

With a reference to FIG. 1, topic identification 104 can be done with a classification method. FIG. 3 shows a flowchart of operations for classification in accordance with one embodiment. The classification method assigns a category (class) to unseen instances (303). An unseen instance can be a document or text that is being added to a corpus. In one embodiment, the classification method is given training instances (301), e.g., a set of instances labeled with categories. The method analyzes the training set and builds a classifier (302). The classifier can then assign (304) a category to a document that is being added to a corpus, e.g., an unseen instance. As a result, a set of labeled instances is obtained (305). An instance may be assigned one or more labels. The classification step may be done with an existing classification method. In one embodiment, a classification method based on a conditional probability model is used where the parameters are estimated with frequencies of different features. In another embodiment, given the predefined value k, classification can be done by analyzing training data and creating training vectors. Then for each new document, its vector is constructed and one or more closest training vectors are found with some similarity/distance measure. The document is then assigned the categories of the one or more training vectors.

In another embodiment the classification step can be performed by reducing a multiclass problem to several binary classification problems as described in the following technical publication: Duan, Kai-Bo; and Keerthi, S. Sathiya (2005). “Which Is the Best Multiclass SVM Method? An Empirical Study”. Proceedings of the Sixth International Workshop on Multiple Classifier Systems. Lecture Notes in Computer Science 3541: 278. Binary classification classifies instances into two classes. An approach of reducing multiclass problem to several binary ones includes performing for each class/category a “one-vs-all” binary classification. For example, an unseen document can be compared to one category and to all of the remaining categories as the second class. In one embodiment, the binary classification can be based on constructing hyperplanes, such as the hyperplanes described in the following technical publication: Cortes, Corinna; and Vapnik, Vladimir N.; “Support-Vector Networks”, Machine Learning, 20, 1995 and U.S. Pat. No. 5,950,146. In one embodiment, classifier construction includes representing, with the above described techniques, all documents as vectors. Training documents are represented as follows {(x,y): yε{−1,1}}, where −1 and 1 are the labels of the first and the second class respectively. Then, a hyperplane w·x−b=0 separating training documents with y=1 from those with y=−1, is constructed, so that the margin is maximal. Thus, the space is divided into two subspaces by the hyperplanes. For an unseen document x, the binary decision is if the document is y=1 or y=−1 and is done as follows: sign(w·x−b).

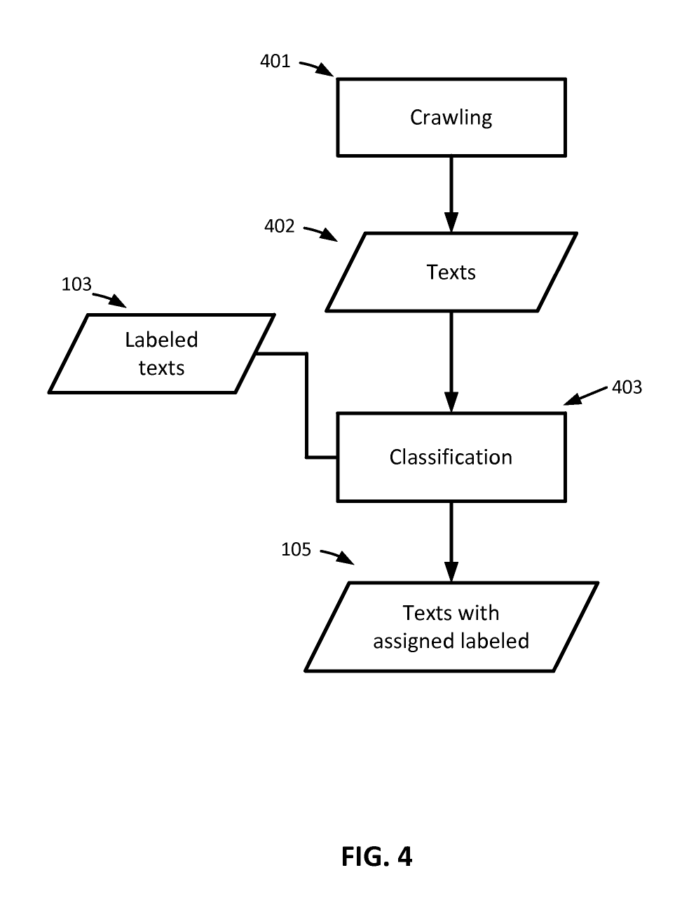

FIG. 4 shows a flowchart of operations for assigning topics to documents in accordance with one embodiment. All the documents in a corpus are retrieved or crawled from a database or a network, such as the internet (401). As a result, a set of texts is obtained (402). A classification method is applied to the texts 402. In some embodiments the classification method uses the set 103 as a training set (403). Any existing classification method can be applied to classify the documents. As a result of the classification, documents are labeled with topics (105).

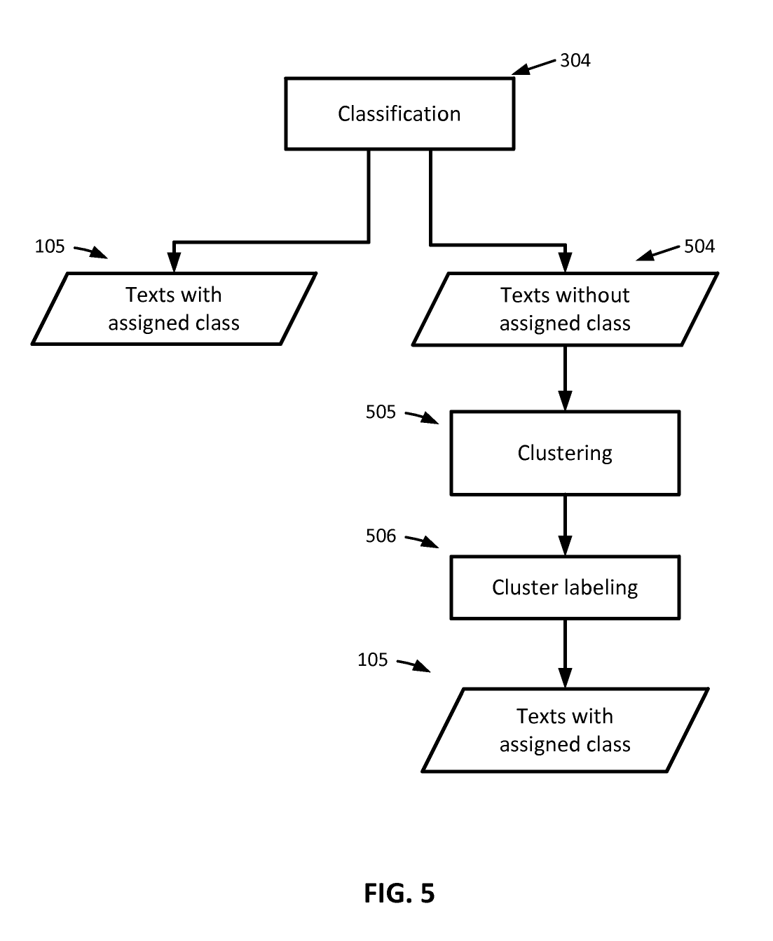

Referring back to FIG. 1, FIG. 2, and FIG. 4, when a corpus includes texts crawled from a network, obtaining a relatively balanced and representative set of texts 103 by the first crawling 201 can be a difficult task. In some embodiments, the labeled texts 103 may not be representative enough to effectively train a classifier 403, e.g., the categories of the labeled texts 103 may not include all the categories needed for labeling the texts 402 obtained by a second crawling 401. To account for this, an method utilizing open class classification can be used. In an open class classifier, the set of labels that can be assigned is not limited to the set of labels of the training set. FIG. 5 shows a flowchart of operations for classifying documents using an open class topic classifier in accordance with one embodiment. In this case, classification 304 produces not only the texts with assigned labels 105 but texts that were not assigned a label 504. The texts that were not assigned a label are those texts for which there was no appropriate label among the labels from the training instances. These unassigned texts can then be clustered 505. The obtained clusters are labeled 506 as described above. As a result, all unseen texts 303 are assigned with labels.

The training set can be updated based upon the documents from the second crawl. In one example, the clustering of the corpus with the documents from the second crawl is used to create a new training set. In yet another example, a subset of the corpus and some documents from the second crawl are clustered to provide an updated training set.

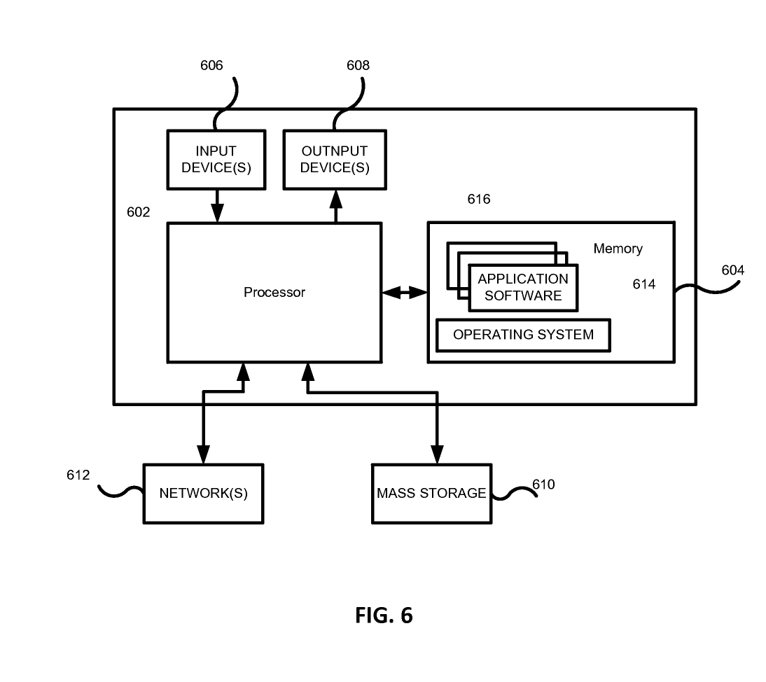

FIG. 6 shows hardware 600 that may be used to implement the techniques described herein. Referring to FIG. 6, the hardware 600 typically includes at least one processor 602 coupled to a memory 904 and having touch screen among output devices 608 which in this case is serves also as an input device 606. The processor 602 may be any commercially available CPU. The processor 602 may represent one or more processors (e.g., microprocessors), and the memory 604 may represent random access memory (RAM) devices comprising a main storage of the hardware 600, as well as any supplemental levels of memory, e.g., cache memories, non-volatile or back-up memories (e.g., programmable or flash memories), read-only memories, etc. In addition, the memory 604 may be considered to include memory storage physically located elsewhere in the hardware 600, e.g., any cache memory in the processor 602 as well as any storage capacity used as a virtual memory, e.g., as stored on a mass storage device 610.

The hardware 600 also typically receives a number of inputs and outputs for communicating information externally. For interface with a user or operator, the hardware 600 usually includes one or more user input devices 606 (e.g., a keyboard, a mouse, imaging device, scanner, etc.) and a one or more output devices 608 (e.g., a Liquid Crystal Display (LCD) panel, a sound playback device (speaker). To embody various embodiments, the hardware 600 must include at least one touch screen device (for example, a touch screen), an interactive whiteboard or any other device which allows the user to interact with a computer by touching areas on the screen. The keyboard is not obligatory in various disclosed embodiments.

For additional storage, the hardware 600 may also include one or more mass storage devices 610, e.g., floppy or other removable disk drive, a hard disk drive, a Direct Access Storage Device (DASD), an optical drive (e.g., a Compact Disk (CD) drive, a Digital Versatile Disk (DVD) drive, etc.) and/or a tape drive, among others. Furthermore, the hardware 600 may include an interface with one or more networks 612 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608, and 612 as is well known in the art.

The hardware 600 operates under the control of an operating system 614, and executes various computer software applications 616, components, programs, objects, modules, etc. to implement the techniques described above. Moreover, various applications, components, programs, objects, etc., collectively indicated by reference 616 in FIG. 6, may also execute on one or more processors in another computer coupled to the hardware 600 via a network 612, e.g., in a distributed computing environment, whereby the processing required to implement the functions of a computer program may be allocated to multiple computers over a network.

In general, the routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements of disclosed embodiments. Moreover, various embodiments have been described in the context of fully functioning computers and computer systems, those skilled in the art will appreciate that the various embodiments are capable of being distributed as a program product in a variety of forms, and that this applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

In the above description numerous specific details are set forth for purposes of explanation. It will be apparent, however, to one skilled in the art that these specific details are merely examples. In other instances, structures and devices are shown only in block diagram form in order to avoid obscuring the teachings.

Reference in this specification to “one embodiment” or “an embodiment” means that a particular feature, structure, or characteristic described in connection with the embodiment is included in at least one embodiment. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

While certain exemplary embodiments have been described and shown in the accompanying drawings, it is to be understood that such embodiments are merely illustrative and not restrictive of the disclosed embodiments and that these embodiments are not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method for creating a topic structure of a corpus while constructing the corpus, the method comprising:
receiving a first set of documents;
clustering the text representation of the first set of documents into original topics;
labeling each document in the first set of documents based upon the clustering of the first set of documents;
building, using a processor, a classifier based on the labeling of each document in the first set of documents;
receiving a second set of documents; and
classifying, using the classifier, each document in the second set of documents into one or more topics from the original topics.

2. The method of claim 1, wherein classifying each document in the second set of documents comprises:
determining an unclassified subset of documents from the second set of documents that were not classified into any of the original topics;
clustering the unclassified subset of documents into new topics not included in the original topics; and
classifying each document in the unclassified subset of documents into one or more topics from the new topics.

3. The method of claim 1, wherein converting each document in the first set of documents into a text representation comprises:
determining a list of words used in all of the documents in the first set of documents;
determining number of times each word is used in each document; and
converting each document into a vector based upon the number of times each word is used each document.

4. The method of claim 3, wherein clustering the text representation of the first set of documents into original topics comprises:
selecting k-number of random vectors;
calculating for each document in the first set a similarity score to each of the random vectors;
assigning each document in the first set to one of the random vectors based upon the similarity score for the each document and the one of the random vectors;
calculating the mass center for each random vector based upon the assigned documents; and
updating the random vectors based upon the mass center of the random vector.

5. The method of claim 4, further comprising:
determining the mass center for each random vector has changed by less than a predetermined value, wherein the assigned documents are the first set of documents clustered into original topics.

6. The method of claim 4, further comprising:
selecting multiple different values for k; and
determining the best value of k based upon a statistical analysis of resulting random vectors for different values of k.

7. The method of claim 1, wherein at least one document in the second set of documents is classified into more than one topic.

8. The method of claim 1, wherein receiving a first set of documents comprises crawling a network for the first set of documents.

9. The method of claim 8, wherein crawling a network for the first set of documents comprises:
determining a yield rate based upon a size of a document and a size of documents present in the corpus; and
adding the document to the first set of documents if the yield rate is above a predetermined threshold.

10. The method of claim 8, wherein receiving a second set of documents comprises crawling a second network for the second set of documents.

11. A system to create a topic structure of a corpus while the corpus is constructed, the system comprising:
one or more electronic processors configured to:
receive a first set of documents;
cluster the text representation of the first set of documents into original topics;
label each document in the first set of documents based upon the clustering of the first set of documents;
build a classifier based on the labeling of each document in the first set of documents;
receive a second set of documents; and
classify, using the classifier, each document in the second set of documents into one or more topics from the original topics.

12. The system of claim 11, wherein to classify each document in the second set of documents the one or more electronic processers are further configured to:
determine an unclassified subset of documents from the second set of documents that were not classified into any of the original topics;
cluster the unclassified subset of documents into new topics not included in the original topics; and
classify each document in the unclassified subset of documents into one or more topics from the new topics.

13. The system of claim 11, wherein to convert each document in the first set of documents into a text representation the one or more electronic processers are further configured to:
determine a list of words used in all of the documents in the first set of documents;
determine number of times each word is used in each document; and
convert each document into a vector based upon the number of times each word is used each document.

14. The system of claim 13, wherein to cluster the text representation of the first set of documents into original topics the one or more electronic processers are further configured to:
select k-number of random vectors;
calculate for each document in the first set a similarity score to each of the random vectors;
assign each document in the first set to one of the random vectors based upon the similarity score for the each document and the one of the random vectors;
calculate the mass center for each random vector based upon the assigned documents; and
update the random vectors based upon the mass center of the random vector.

15. The system of claim 14, wherein the one or more electronic processers are further configured:
select multiple different values for k; and
determine the best value of k based upon a statistical analysis of resulting random vectors for different values of k.

16. The system of claim 11, wherein at least one document in the second set of documents is classified into more than one topic.

17. A non-transitory computer-readable medium having instructions stored thereon to create a topic structure of a corpus while the corpus is constructed, the instructions comprising:
instructions to receive a first set of documents;
instructions to cluster the text representation of the first set of documents into original topics;
instructions to label each document in the first set of documents based upon the clustering of the first set of documents;
instructions to build a classifier based on the labeling of each document in the first set of documents;
instructions to receive a second set of documents; and
instructions to classify, using the classifier, each document in the second set of documents into one or more topics from the original topics.

18. The non-transitory computer-readable medium of claim 17, wherein the instructions to classify each document in the second set of documents further comprise:
instructions to determine an unclassified subset of documents from the second set of documents that were not classified into any of the original topics;
instructions to cluster the unclassified subset of documents into new topics not included in the original topics; and
instructions to classify each document in the unclassified subset of documents into one or more topics from the new topics.

19. The non-transitory computer-readable medium of claim 17, wherein the instructions to convert each document in the first set of documents into a text representation further comprise:
instructions to determine a list of words used in all of the documents in the first set of documents;
instructions to determine number of times each word is used in each document; and
instructions to convert each document into a vector based upon the number of times each word is used each document.

20. The non-transitory computer-readable medium of claim 19, wherein the instructions to cluster the text representation of the first set of documents into original topics further comprise:
instructions to select k-number of random vectors;
instructions to calculate for each document in the first set a similarity score to each of the random vectors;
instructions to assign each document in the first set to one of the random vectors based upon the similarity score for the each document and the one of the random vectors;
instructions to calculate the mass center for each random vector based upon the assigned documents; and
instructions to update the random vectors based upon the mass center of the random vector.

21. The non-transitory computer-readable medium of claim 20, wherein the instructions further comprise:
instructions to select multiple different values for k; and
determine the best value of k based upon a statistical analysis of resulting random vectors for different values of k.

22. The non-transitory computer-readable medium of claim 17, wherein at least one document in the second set of documents is classified into more than one topic.
